(19) United States
(12) Patent Application Publication
(10) Pub. No.: US 2012/0300262 A1
(43) Pub. Date: Nov. 29, 2012

(54) DATA GENERATING APPARATUS, DATA GENERATING METHOD, AND STORAGE MEDIUM

(76) Inventors: Masashi KURANOSHITA, Tokyo (JP); Shinichi Nakazawa, Tokyo (JP)

(21) Appl. No.: 13/478,294

(22) Filed: May 23, 2012

(30) Foreign Application Priority Data
May 24, 2011 (JP) 2011-115305

(51) Int. Cl. G06K 15/02

(52) U.S. Cl. 358/1.18

(57) ABSTRACT

First imposition data are referred to in order to judge whether or not side stitching is included in a first processing sequence. If it is determined that side stitching is included in the first processing sequence, a job including a printing process and a sheet folding process is defined with respect to each signature to be side-stitched. Print data corresponding to a second sheet are generated with respect to each job.

### CROSS-REFERENCE TO RELATED APPLICATION

This application is based upon and claims the benefit of priority from Japanese Patent Application No. 2011-115305 filed on May 24, 2011, of which the contents are incorporated herein by reference.

### BACKGROUND OF THE INVENTION

1. Field of the Invention

The present invention relates to a data generating apparatus, a data generating method, and a storage medium storing a program for generating print data to simulatively reproduce, on a second sheet, the form of a final print, which is produced by performing a first processing sequence including a sheet folding process on a first print, wherein the first print is formed based on a first sheet which is different in size from the second sheet, and also generating first imposition data corresponding to the first sheet, and page description data representative of a plurality of pages.

2. Description of the Related Art

In recent years, CTP (Computer To Plate) technology for directly producing printing plates from electronic data without the need for any intermediate mediums has been in widespread use in the printing and platemaking field. Heretofore, there have also been available POD (Print On Demand) systems for producing prints in relatively small lots using small-scale digital printers such as electrophotographic printers, inkjet printers, etc., rather than large-scale printing presses such as offset presses or the like. Various techniques have been proposed for efficiently printing CTP data with a plurality of pages imposed thereon by means of POD systems without the use of printing plates.

Japanese Laid-Open Patent Publication No. 2009-004912 discloses a method of and an apparatus for generating POD data, in which CTP data for large-size sheets are relocated pagewise and then imposed on differently sized sheets.

If a POD system is introduced into a proofreading process, then it is possible to produce a proof that is an evolved version of a dummy book, which is used to confirm the form of a bound book. More specifically, the contents of pages are actually printed and the printed contents are processed in order to produce a finished print sample that simulates the form (including the size) of a final print. The finished print sample is convenient for outsourcers and advertisement agencies, because it allows them to imagine the form (finish) of the final print.

Japanese Laid-Open Patent Publication No. 2011-018230 reveals an apparatus for and a method of imposing pages with POD imposition data, which have been converted from CTP imposition data. The disclosed apparatus and method can reduce the amount of data required to be handled, and can also make fine adjustments to the layout of the imposition data. The disclosed technique is effective in producing prints in very small lots, particularly finished print samples.

### SUMMARY OF THE INVENTION

The present invention has been made in connection with the technical concept disclosed in Japanese Laid-Open Patent Publication No. 2011-018230. It is an object of the present invention to provide a data generating apparatus, a data generating method, and a storage medium storing a program for producing a finished print sample using a POD system, without causing bookbinding defects such as incorrect collating, etc., to occur.

According to the present invention, there is provided a data generating apparatus for generating print data to simulatively reproduce, on a second sheet, the form of a final print, which is produced by performing a first processing sequence including a sheet folding process on a first print that is formed based on a first sheet, wherein the first sheet is different in size from the second sheet, and also generating first imposition data corresponding to the first sheet, and page description data representative of a plurality of pages.

The data generating apparatus includes a side stitch judging section, which refers to the first imposition data in order to judge whether or not side stitching is included in the first processing sequence, a job defining section for defining a job including a printing process and a sheet folding process, with respect to each signature to be side-stitched, if the side stitch judging section determines that side stitching is included in the first processing sequence, and a data generator for generating the print data corresponding to the second sheet, with respect to each job defined by the job defining section.

The data generating apparatus includes the side stitch judging section, which judges whether or not side stitching is included in the first processing sequence, and the data generator for generating the print data corresponding to the second sheet, with respect to each job defined per signature to be side-stitched, if the side stitch judging section determines that side stitching is included in the first processing sequence. Consequently, by successively registering jobs, each of which includes a printing process and a sheet folding process, the sheet folding processes for producing respective signatures can be carried out with suitable timings. Therefore, even if a bookbinding process includes side stitching, the form of the final print using the first sheet can be simulatively reproduced using the second sheet. In other words, a finished print sample can be produced using a POD system, without causing bookbinding defects such as incorrect collating, etc., to occur.

The print data preferably comprises second imposition data corresponding to the second sheet.

The data generating apparatus preferably further comprises an imposition processor for imposing each page represented by the page description data onto the second sheet according to the second imposition data generated by the data generator.

The print data preferably comprise imposed data corresponding to the second sheet, the imposed data being generated based on imposed data corresponding to the first sheet, onto which each page represented by the page description data is imposed according to the first imposition data.

Preferably, a second processing sequence including a sheet folding process is performed on a second print including images on the second sheet in order to simulatively reproduce the form of the final print. The number of folds formed by the sheet folding process included in the first processing sequence should be greater than the number of folds formed by the sheet folding process included in the second processing sequence.

The first processing sequence preferably includes a sheet folding process, which represents a plurality of folds to be formed.

The second processing sequence preferably includes a sheet folding process, which represents one fold to be formed.

According to the present invention, there also is provided a data generating method for generating print data to simulatively reproduce, on a second sheet, the form of a final print, which is produced by performing a first processing sequence including a sheet folding process on a first print that is formed based on a first sheet, wherein the first sheet is different in size from the second sheet, and also generating first imposition data corresponding to the first sheet, and page description data representative of a plurality of pages. The method comprises the steps of referring to the first imposition data to judge whether or not side stitching is included in the first processing sequence, defining a job including a printing process and a sheet folding process, with respect to each signature to be side-stitched, if it is determined that side stitching is included in the first processing sequence, and generating print data corresponding to the second sheet, with respect to each job that is defined.

According to the present invention, there also is provided a storage medium storing therein a program for generating print data to simulatively reproduce, on a second sheet, the form of a final print, which is produced by performing a first processing sequence including a sheet folding process on a first print that is formed based on a first sheet, wherein the first sheet is different in size from the second sheet, and also generating first imposition data corresponding to the first sheet, and page description data representative of a plurality of pages. The program enables a computer to function as a side stitch judging section for referring to the first imposition data to judge whether or not side stitching is included in the first processing sequence, a job defining section for defining a job including a printing process and a sheet folding process, with respect to each signature to be side-stitched, if the side stitch judging section determines that side stitching is included in the first processing sequence, and a data generator for generating the print data corresponding to the second sheet, with respect to each job defined by the job defining section.

With the data generating apparatus, the data generating method, and the storage medium according to the present invention, it is judged whether or not side stitching is included in the first processing sequence, and the print data corresponding to the second sheet are generated with respect to each job defined per signature to be side-stitched, if it is determined that side stitching is included in the first processing sequence. Consequently, by successively registering jobs each including a printing process and a sheet folding process, the sheet folding processes for producing respective signatures can be carried out with suitable timings. Therefore, even if a bookbinding process includes side stitching, the form of the final print using the first sheet can be simulatively reproduced using the second sheet. In other words, a finished print sample can be produced using a POD system, without causing bookbinding defects such as incorrect collating, etc., to occur.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view showing the configuration of a print production system incorporating therein a data generating apparatus according to an embodiment of the present invention;

FIG. 2 is an electric block diagram of an image editing apparatus shown in FIG. 1;

FIG. 3 is a flowchart of a printing sequence carried out by the print production system shown in FIG. 1;

FIG. 4 is a flowchart of a first operation sequence of the image editing apparatus for producing a finished print sample in step S5 shown in FIG. 3;

FIG. 5A is a front elevational view of a first print;

FIG. 5B is a diagram showing an example of a job represented by first imposition data;

FIG. 5C is a diagram showing an example of a job represented by second imposition data;

FIG. 6A is a diagram that illustrates a process for generating imposed data for printing plates;

FIG. 6B is a diagram that illustrates a process for generating imposed data for use in a POD system;

FIG. 7 is a diagram showing the data structure of second imposition data;

FIG. 8 is a flowchart of a second operation sequence of the image editing apparatus for producing a finished print sample in step S5 shown in FIG. 3;

FIG. 9A is a front elevational view of second prints produced by a POD machine;

FIG. 9B is a perspective view of a first signature produced by folding the second prints shown in FIG. 9A;

FIG. 10 is an exploded perspective view of a finished book sample; and

FIG. 11 is a diagram that illustrates a modified process of generating imposed data for use in a POD system.

### DESCRIPTION OF THE PREFERRED EMBODIMENTS

Data generating methods according to preferred embodiments of the present invention in relation to a data generating apparatus, a recording medium storing a program therein, and a print production system for carrying out the data generating methods will be described in detail below with reference to the accompanying drawings.

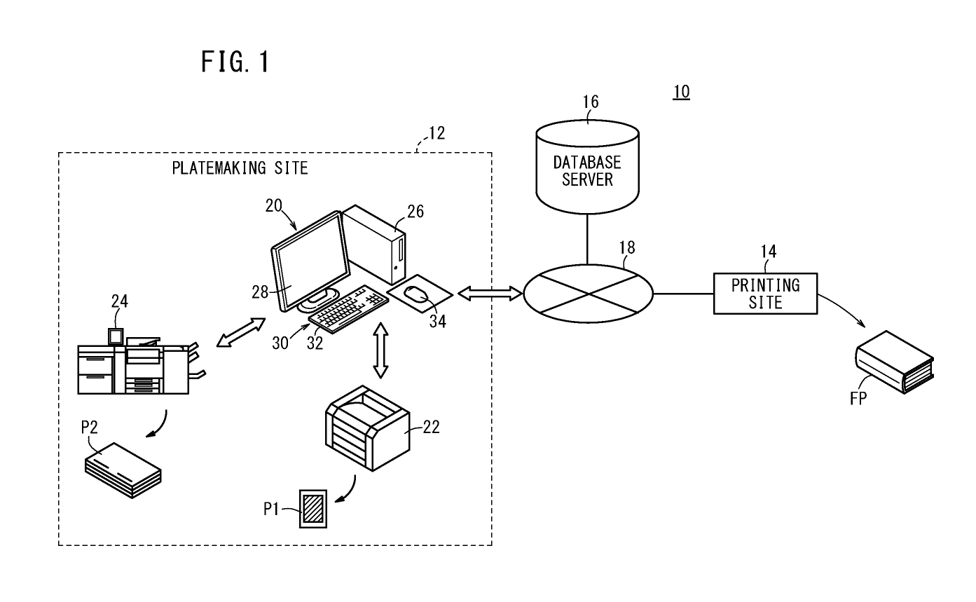

FIG. 1 is a schematic view showing the configuration of a print production system 10 incorporating therein an image editing apparatus 20 as a data generating apparatus according to an embodiment of the present invention.

As shown in FIG. 1, the print production system 10 basically includes a platemaking site 12, a printing site 14, a database server 16, and a network 18. The platemaking site 12 includes an image editing apparatus 20, a proof press 22, and a POD machine 24.

The image editing apparatus 20 generates edited data per page in a page description language (hereinafter referred to as “PDL”), e.g., PDL-format data in color channels of four colors (CMYK) or three colors (RGB).

PDL refers to a language which is descriptive of image information including document information, position information, color information (including density information), etc., of characters, figures, etc., in a “page” that serves as an output unit for printing, displaying, or the like. Known types of PDL include PDF (Portable Document Format according to ISO32000-1:2008), PostScript (registered trademark) of AdobeSystems, and XPS (XML Paper Specification).

The image editing apparatus 20 includes various functions to perform desired image processing sequences including, for example, a preflight process, a color conversion process, a layout process, etc., on PDL-format edited data, a conversion process for converting the PDL-format edited data into raster-format image data, e.g., bitmap or TIFF image data (hereinafter also referred to as raster image data), and a sending process for sending print data to the proof press 22 or the POD machine 24.

The image editing apparatus 20 includes a main unit 26, a display unit 28, and an input unit 30 including a keyboard 32 and a mouse 34. The mouse 34 functions as a pointing device and may be replaced with a track pad or a track ball.

The proof press 22 is an output device for producing a proof print P1 to be proofread. The proof press 22 may comprise a DDCP (Direct Digital Color Proofer), which is equivalent in performance to an offset press, an ink jet color proofer, a low-resolution color laser printer (electrophotographic printer), an ink jet printer, or the like.

The POD machine 24 is an output apparatus for producing a finished print sample P2 to be proofread. The finished print sample P2 is a print sample, which serves to simulatively reproduce a final print FP produced at the printing site 14, i.e., a dummy book containing printed contents per page. The POD machine 24 is capable of performing at least a printing function for forming images on mediums (not shown) and outputting jobs, and a folding function for folding jobs. The POD machine 24 also is capable of performing a binding function for binding at least one job.

The database server 16 saves, updates, and deletes various data files required to produce final prints FP. The data files include material data (contents data) from production companies, not shown, proof data, platemaking data, job tickets, e.g., JDF (Job Definition Format) files, ICC (International Color Consortium) profiles, color sample data, etc.

The network 18 is constructed according to communication standards such as Ethernet (registered trademark) or the like. The platemaking site 12, the printing site 14, and the database server 16 are connected to each other over the network 18. If the platemaking site 12 and the printing site 14 are geographically spaced apart from each other, platemaking data may be exchanged between the platemaking site 12 and the printing site 14 through the network 18.

The printing site 14 includes an image processing device for performing a desired image processing sequence on printing plate data, a platesetter for creating printing plates, an offset press for printing desired images on various mediums (hereinafter referred to as a “first sheet”) to produce prints (hereinafter referred to as a “first print”), and various devices for performing surface processing and at least one processing sequence (hereinafter referred to as a “first processing sequence”) such as folding, binding, cutting, etc., on the first prints. Preferably plural processing sequences are performed. The printing site 14 produces at least one first print, and thereafter performs a first processing sequence on the first print in order to produce a final print FP (a casebound book as shown in FIG. 1). The platesetter and the offset press may be replaced with a digital printing press, which is capable of producing prints directly from printing plate data.

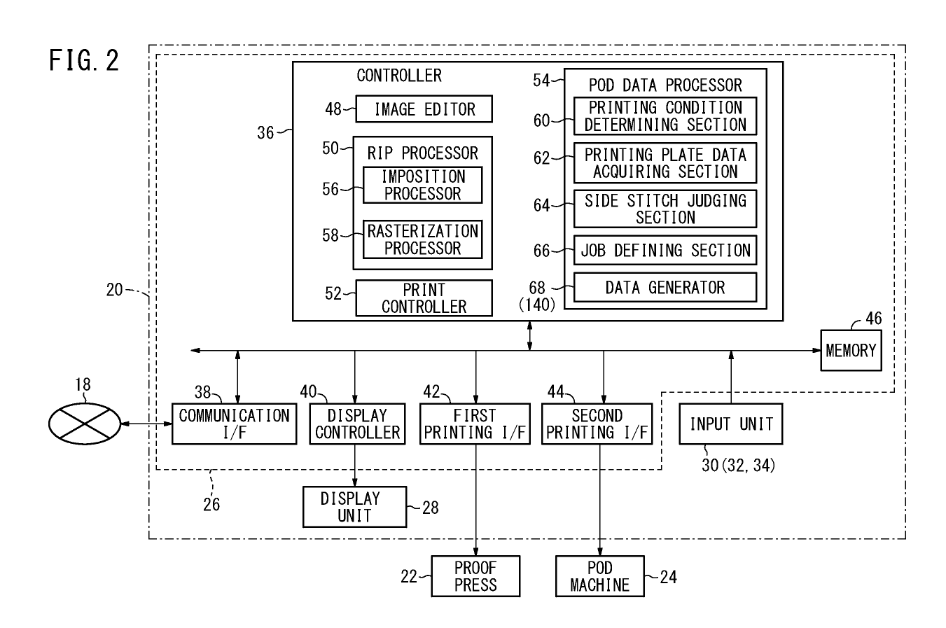

FIG. 2 is an electric block diagram of the image editing apparatus 20 shown in FIG. 1.

As shown in FIG. 2, the main unit 26 includes a controller 36, a communication I/F 38, a display controller 40, a first printing I/F 42, a second printing I/F 44, and a memory 46 (storage medium).

The communication I/F 38 is an interface for sending electric signals to and receiving electric signals from various external apparatus. For example, the communication I/F 38 can acquire material data provided by a production company, not shown. The communication I/F 38 can also acquire various items of information such as printing plate data, ICC profiles, etc., which are managed and saved by the database server 16.

The display controller 40 comprises a control circuit for controlling the display unit 28 under the control of the controller 36. More specifically, upon the display controller 40 outputting a display control signal to the display unit 28 via a non-illustrated I/F, the display unit 28 is energized to display various images.

The first printing I/F 42 and the second printing I/F 44 are interfaces for sending electric signals representing printing data to the proof press 22 and the POD machine 24. More specifically, the first printing I/F 42 sends an electric signal to the proof press 22 so as to enable the proof press 22 to produce a desired proof print P1, and the second printing I/F 44 sends an electric signal to the POD machine 24 in order to produce a desired finished print sample P2.

The memory 46 stores programs and data, which are required for the controller 36 to control various parts. The memory 46 may comprise a recording medium such as a nonvolatile memory, a hard disk, or the like.

The controller 36 comprises a processor such as a CPU. The controller 36 reads and executes programs stored in the memory 46 in order to perform the functions of an image editor 48, a RIP processor 50, a print controller 52, and a POD data processor 54.

The image editor 48 generates edited data per page from material data representing characters, figures, patterns, pictures, etc. The image editor 48 also generates imposition data (e.g., job tickets) for imposing a sheet of a given size per page according to a binding process and a sheet folding process, which have been designated.

The RIP processor 50 includes an imposition processor 56 for imposing edited data per page by referring to imposition data to thereby produce imposed data, and a rasterization processor 58 for performing a rasterizing process on the imposed data. The rasterizing process includes a data format conversion process for converting data from a PDL format into a raster format, and a color matching process using an ICC profile.

The print controller 52 issues appropriate output commands to the POD machine 24. Such output commands include at least a printing command and a sheet folding command, and may also include a binding command. If the print controller 52 receives a plurality of jobs simultaneously, the jobs are handled in sequence by the print controller 52.

The POD data processor 54 includes a printing condition determining section 60 for determining printing conditions for the POD machine 24, a printing plate data acquiring section 62 for acquiring printing plate data to be supplied to the printing site 14, a side stitch judging section 64 for referring to and analyzing printing plate data acquired by the printing plate data acquiring section 62 in order to judge whether or not side stitching is included in the first processing sequence, a job defining section 66 for defining at least one job to be carried out by the POD machine 24, and a data generator 68 for generating POD data (print data) depending on at least one job carried out by the POD machine 24.

The term “printing plate data” as used herein refers to various data supplied to processes performed in the printing site 14. The term “POD data” refers to various data supplied to the POD machine 24. The printing plate data or the POD data include not only imposed raster data or vector data, but also imposition data and edited data per page.

The present embodiment is based on the premise that the size (e.g., B1 size) of a first sheet corresponding to printing plate data is different from the size (e.g., SRA4 size) of a second sheet corresponding to POD data. When the POD machine 24 produces a finished print sample P2, the POD machine 24 cannot use the printing plate data as they are. The POD data processor 54 needs to generate new POD data, which are suitable for a combination of a second sheet and a second processing sequence, wherein the combination of the second sheet and the second processing sequence differs from the combination of the first sheet and the first processing sequence. The term “second sheet” refers to a sheet that is used for the printing process performed by the POD machine 24. The term “second processing sequence” refers to processes, e.g., surface processing, folding, binding, cutting, etc., which are performed on a print (hereinafter referred to as a “second print”) that carries a desired image on a second sheet.

The image editing apparatus 20 according to the present embodiment is constructed basically as described above.

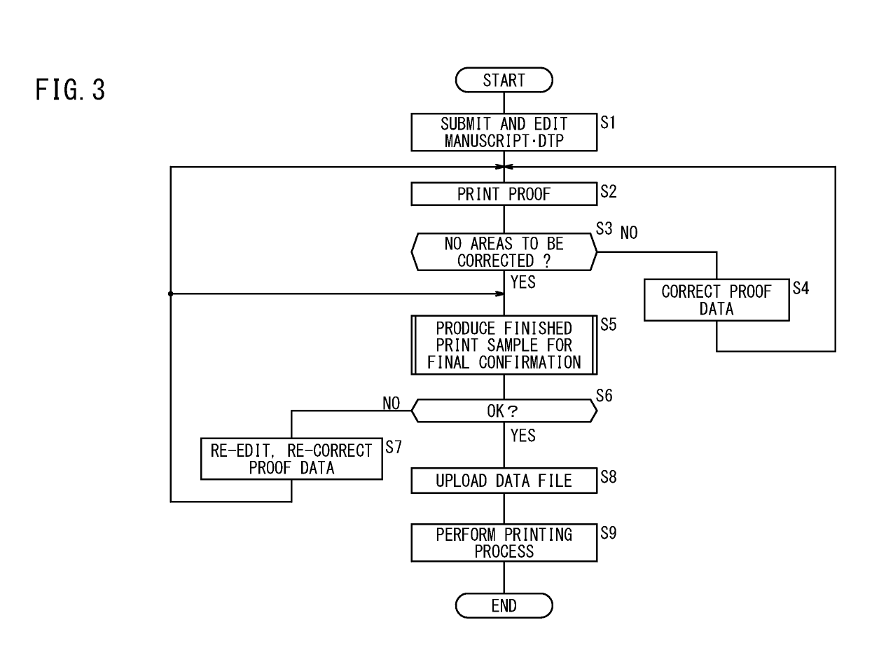

A printing sequence carried out by the print production system 10 will be described primarily with reference to the flowchart shown in FIG. 3. The platemaking site 12 (see FIG. 1) operates according to steps S1 through S8 shown in FIG. 3. A proofreading process performed at the platemaking site 12 according to the present embodiment will be described below.

First, a designer belonging to a production company or the like submits material data for a final print FP. In step S1, an operator belonging to the platemaking site 12 edits the material data in a DTP process. For example, the image editing apparatus 20 acquires material data, which have been saved in the database server 16, via the network 18 and the communication I/F 38, and then stores the acquired material data in the memory 46.

Depending on the editing process carried out by the operator, the image editor 48 generates edited data per page from one or more material data. Then, the image editor 48 generates imposition data (hereinafter referred to as “first imposition data”) according to a binding process and a sheet folding process, which have been designated. After the material data have been submitted and the DTP process is completed, the image editor 48 temporarily records the edited data per page and the first imposition data as proof data in the memory 46.

Then, in step S2, the operator instructs the proof press 22 to produce a proof print P1 in order to proofread the proof data. More specifically, in response to a print instruction from the operator, the RIP processor 50 (see FIG. 2) converts the proof data acquired from the memory 46 into imposed raster data. Then, the proof press 22 acquires the raster data via the first printing I/F 42, and prints an image on a medium (not shown) based on the raster data, thereby producing the proof print P1. At this time, the proof press 22 may adjust the colors of the proof print P1 according to a known color matching technology in order to reproduce the colors of the final print FP.

Then, in step S3, the operator confirms whether or not there is an area to be corrected in the proof data. If an area to be corrected exists within the proof data, then in step S4, the operator corrects the proof data at the present time. The operator repeats the proofreading process in steps S2 through S4.

If there is no area to be corrected in the proof data, then in step S5, the operator instructs the POD machine 24 to produce a finished print sample P2 which is simulative of a final print FP. In step S6, an approver judges whether or not the finished print sample P2 is acceptable, thereby finally confirming the proof data. The approver may be the same person as the operator who carries out steps S1 through S4, however, the approver may also be a different person from the operator, e.g., a person in charge in a production company. Operations of the image editing apparatus 20 for producing the finished print sample P2 will be described later.

If the proof data are not accepted in step S6, then in step S7, the proof data are re-edited or re-corrected. Thereafter, if the change in the proof data is small, control proceeds to step S5 in order to produce the finished print sample P2. Otherwise, step S2 is repeated, whereby the proof press 22 produces the proof print P1 again. Steps S2 through S7 are repeated until the approver accepts the proof data and approves the start of a next printing process.

If the proof data are accepted in step S6, then in step S8, the operator uploads the accepted proof data into the database server 16, thereby saving the accepted proofread data as a data file. Finally, a print operator belonging to the printing site 14 produces at least one first print based on the accepted proof data downloaded from the database server 16, and performs a first processing sequence on the first print in order to produce a final print FP in step S9.

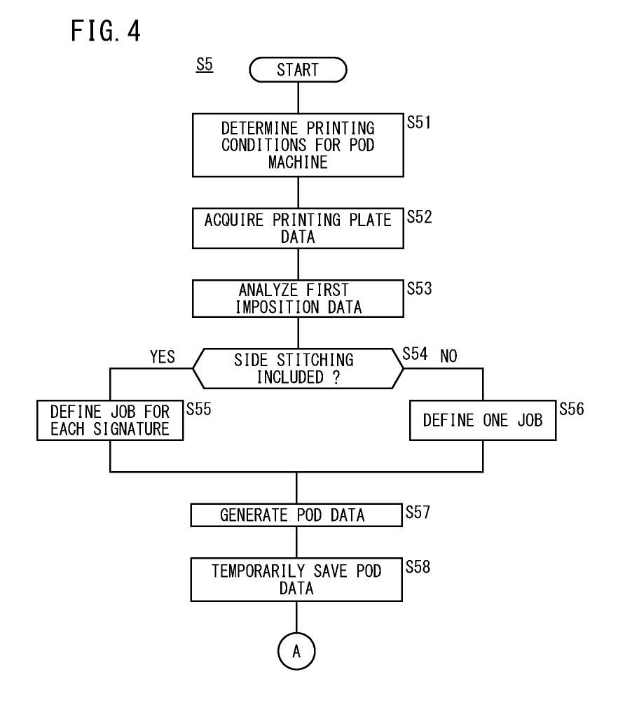

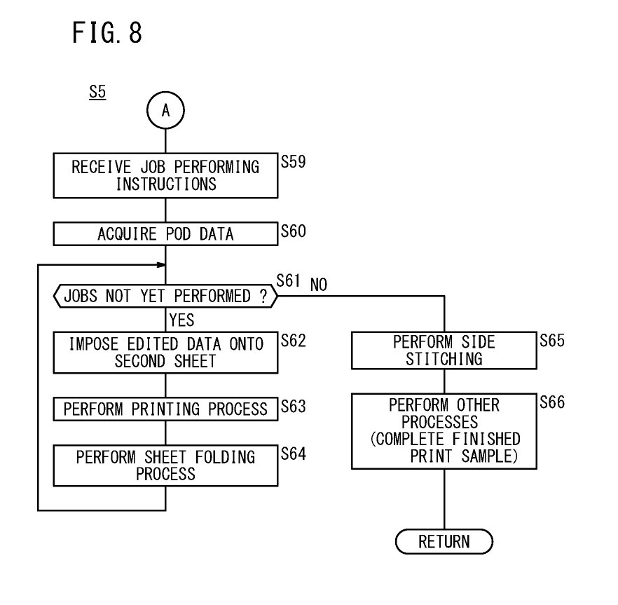

As described above, the final print FP can be produced by the print production system 10. Operations performed by the image editing apparatus 20 in step S5 for producing the finished print sample P2 (see FIG. 3) will be described in detail below with reference to the flowcharts shown in FIGS. 4 and 8.

In the case that a finished print sample P2 is produced to the size of a final print FP, since the sizes of the first and second sheets are different from each other, the number of pages that are to be placed on one sheet differs on the first and second sheets. For example, if the first processing sequence includes a sheet folding process for folding a sheet a plurality of times, then a signature, which includes a plurality of jobs folded together, is produced by a sheet folding process and a cutting process. If such a signature is simulatively reproduced using small-size sheets, then instructional information for folding the jobs together may be missing during imposition. More specifically, if the first processing sequence includes side stitching, then a sheet folding process for forming a plurality of signatures (each made up of a plurality of jobs) to be side-stitched may not be properly performed, possibly resulting in incorrect collating. Such problems need to be taken into account at the time that the POD data are generated.

As shown in FIG. 4, in step S51, the printing condition determining section 60 determines printing conditions for the POD machine 24. For example, the printing condition determining section 60 determines double-faced printing and one fold to be formed in a sheet folding process, and selects a sheet having a maximum size from among sheets (separate sheets or roll sheets) that can be fed at present. The printing condition determining section 60 also selects color or monochromatic printing, amounts of color materials, an image quality mode, etc.

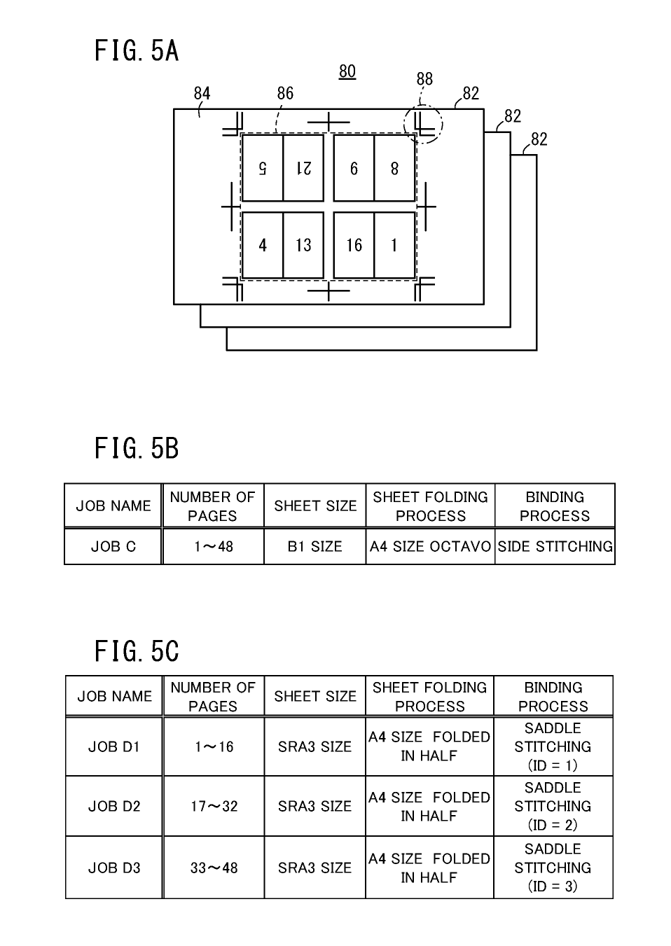

Then, in step S52, the printing plate data acquiring section 62 acquires printing plate data from the memory 46. For example, it is assumed that a job C, as shown in FIGS. 5A and 5B, is defined as printing plate data according to first imposition data. More specifically, it is assumed that there are 48 imposed pages (pages 1 through 48), first sheets 82 are of B1 size, a sheet folding process for an octavo is selected (each page is of A4 size), and a side stitching process is selected.

As shown in FIG. 5A, a first print 80 includes a plurality of first sheets 82 of B1 size, each of the first sheets 82 having on a first surface 84 thereof a print area 86 representative of a layout of eight pages, and a plurality of register marks 88 serving as signs for registering the first sheets 82 at the time that the first sheets 82 are printed.

Then, in step S54, the side stitch judging section 64 refers to the first imposition data in order to judge whether or not side stitching is included in the first processing sequence. If the side stitch judging section 64 determines that side stitching is included in the first processing sequence, then in step S55, the job defining section 66 defines a job with respect to each signature to be side-stitched. If the side stitch judging section 64 determines that side stitching is not included in the first processing sequence, then in step S56, the job defining section 66 defines one job. The “job” includes at least a sheet folding process and a binding process.

As shown in FIG. 5B, since the first processing sequence includes side stitching, control proceeds from step S54 to step S55. Since one signature of octavo is produced from one first sheet 82 (see FIG. 5A), the job defining section 66 defines jobs D1, D2, D3 for three signatures.

In general, POD machines 24 capable of handling larger printable sheets are more expensive, whereas POD machines 24 that handle smaller printable sheets are less expensive. As shown in FIGS. 5B and 5C, the number of folds (three folds) to be formed by the sheet folding process included in the first processing sequence is greater than the number of folds (one fold) to be formed by the sheet folding process included in the second processing sequence. Thus, the finished print sample P2 can be produced inexpensively. If a sheet is folded in half (i.e., if the number of folds to be formed is one), then one sheet can represent four pages, thereby reducing the unit cost (running cost) required to produce the finished print sample P2.

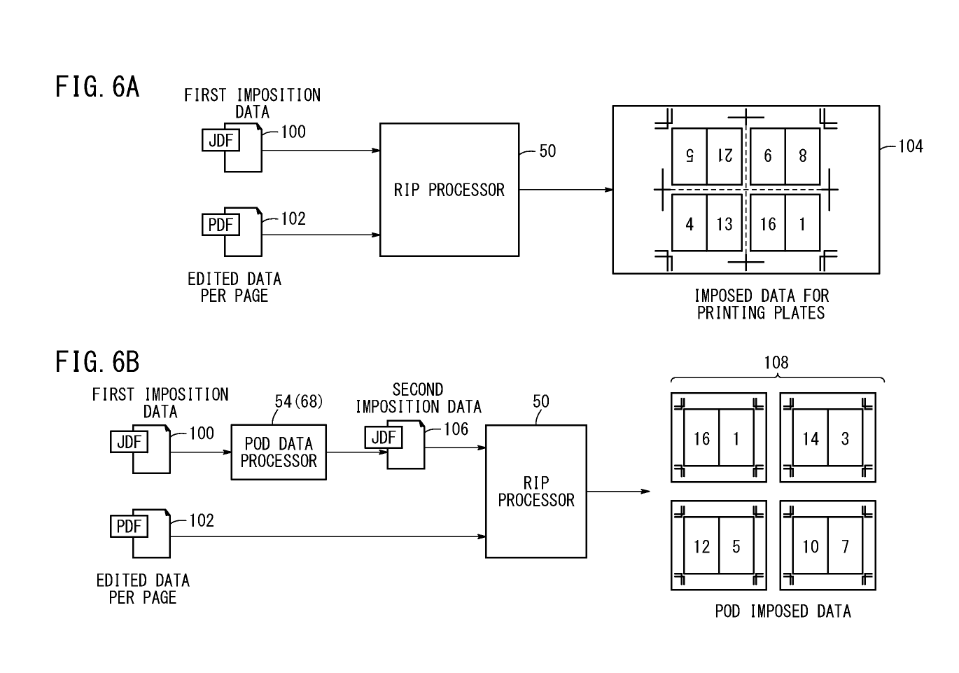

Then, in step S57, the data generator 68 generates POD data corresponding to the jobs D1 through D3 defined in step S55 or S56. According to the present embodiment, the data generator 68 generates second imposition data 106 representative of the jobs D1 through D3 as POD data. A process for generating second imposition data 106 will be described below with reference to FIGS. 6A and 6B.

As shown in FIG. 6A, the RIP processor 50 refers to first imposition data 100 corresponding to a first sheet 82 (see FIG. 5A), and imposes edited data 102 per page onto the first sheet 82, thereby producing imposed data 104 for printing plates.

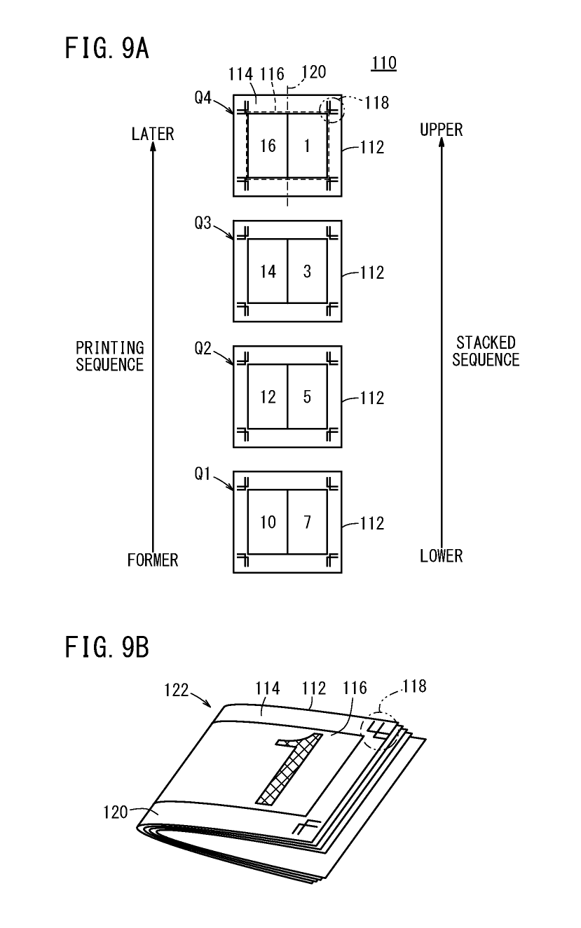

As shown in FIG. 6B, prior to performing a RIP process, the POD data processor 54 (data generator 68) generates second imposition data 106 corresponding to a second sheet 112 (see FIG. 9A) from the first imposition data 100. The RIP processor 50 refers to the second imposition data 106, and imposes the edited data 102 per page onto the second sheet 112, thereby producing POD imposed data 108. According to the present process, only imposed data may be replaced without requiring changes to the edited data 102 per page, for thereby performing a printing process suitable for the POD machine 24. Thus, the process is highly efficient.

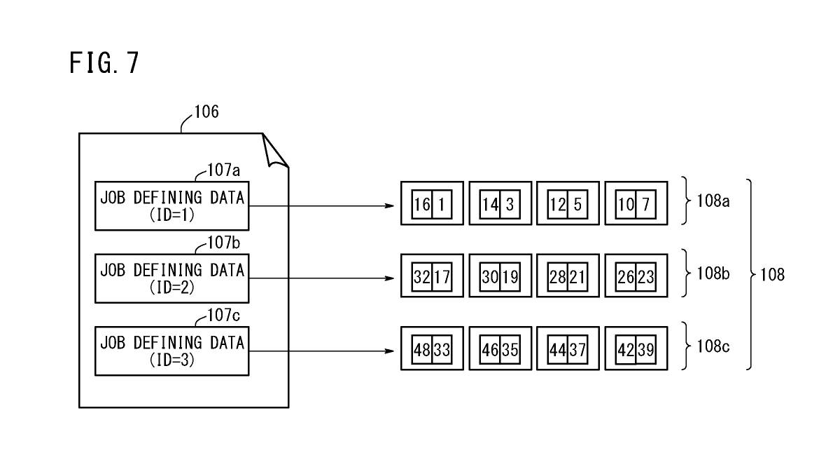

As shown in FIG. 7, the second imposition data 106 comprise one data file including a plurality of jobs. More specifically, the second imposition data 106 include job defining data 107a defining the job D1, job defining data 107b defining the job D2, and job defining data 107c defining the job D3. The job defining data 107a through 107c correspond respectively to imposed data 108a through 108c.

According to the job definition format JDF, for example, each job may be defined (classified) using a binding ID (hereinafter also referred to as an “ID”). In FIGS. 7C and 7, ID=1 is assigned to job D1, ID=2 is assigned to job D2, and ID=3 is assigned to job D3.

The second imposition data 106 may be generated by the process disclosed in Japanese Laid-Open Patent Publication No. 2011-018230. More specifically, the data structure of the first imposition data 100 (JDF) is duplicated, and various parameters representative of page numbers, an imposition process, a sheet size, a print area and register mark layout, etc., are corrected. The second imposition data 106 may comprise a group of data files defined with respect to each job. Therefore, the second imposition data 106 may be made up of a plurality of data files.

Then, in step S58 (see FIG. 4), the controller 36 temporarily stores and saves the POD data (second imposition data 106) generated in step S57 in the memory 46.

As shown in FIG. 8, control then proceeds from step S58 to step S59. In step S59, the image editing apparatus 20 receives instructions to perform jobs D1 through D3, which are generated with given timings. At this time, the print controller 52 registers and manages the jobs so that jobs D1 through D3 will be performed in an ascending sequence of the job IDs, i.e., jobs D1 through D3 are performed in this order.

Then, in step S60, the RIP processor 50 acquires POD data from the memory 46. More specifically, the RIP processor 50 acquires the edited data 102 per page and the second imposition data 106.

Then, in step S61, the print controller 52 confirms whether or not there are any remaining jobs that have not yet been performed. Since jobs D1 through D3 are initially registered in a not yet performed queue (S61: YES), control proceeds to step S62.

In step S62, the imposition processor 56 imposes the edited data 102 per page onto the second sheet 112 (see FIG. 9) in accordance with the second imposition data 106. The rasterization processor 58 performs a rasterizing process on the imposed data, thereby generating POD imposed data 108 (see FIG. 6B) suitable for use by the POD machine 24.

Then, in step S63, the print controller 52 controls the POD machine 24 in order to perform a printing process on the second sheet 112 (FIG. 9). As shown in FIG. 9A, a second print 110 made up of four jobs Q1 through Q4 corresponding to the job D1 is produced. Each of the jobs Q1 through Q4 includes images printed on both surfaces of the second sheet 112. For example, the job Q4 has a print area 116 on one surface 114 thereof, which is representative of a layout of two pages, and a plurality of register marks 118 serving as signs for registering the second sheets 112 at the time that the second sheets 112 are printed.

Then, in step S64, the print controller 52 controls the POD machine 24 to perform a sheet folding process. After the jobs Q1, Q2, Q3, Q4 have been printed in this order in step S63, the jobs Q1, Q2, Q3, Q4 are stacked together in alignment with each other. The POD machine 24 then folds the jobs Q1 through Q4 according to the folding function thereof in order to form a peak fold along a fold line 120, thereby producing a first signature 122 as shown in FIG. 9B.

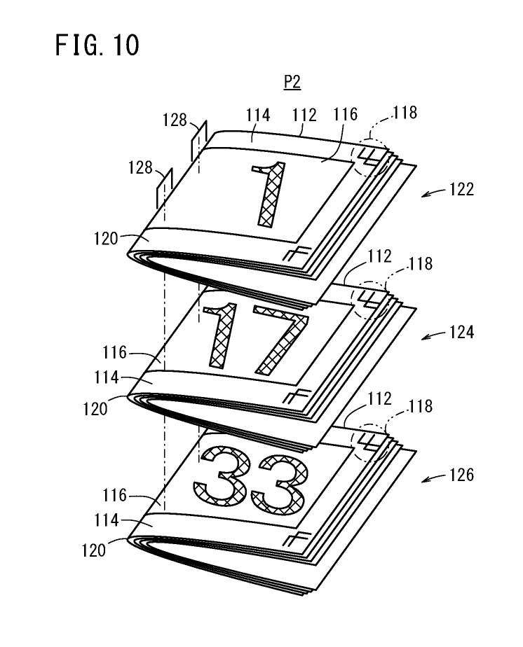

Then, control returns to step S61, in which the print controller 52 confirms whether or not there are jobs that have not yet been performed. In other words, steps S61 through S64 are repeated until there are no jobs remaining to be performed. With respect to the first print 80 shown in FIGS. 5A and 5B, a second signature 124 (see FIG. 10) corresponding to the job D2 is produced, and a third signature 126 (see FIG. 20) corresponding to the job D3 is produced, in the same manner as with the first signature 122.

Then, in step S65, the first signature 122, the second signature 124, and the third signature 126 are side-stitched. If the POD machine 24 includes a binding function, then the print controller 52 may control the POD machine 24 in order to perform a side stitching process. If the POD machine 24 does not have a binding function, then the print controller 52 may control a binding machine in the platemaking site 12 in order to perform a side stitching process.

As shown in FIG. 10, the first signature 122, the second signature 124, and the third signature 126, which are stacked successively upward in this order, are side-stitched from the first signature 122 using two staples 128. In this manner, as shown in FIG. 10, a finished print sample P2 is produced, which has page numbers 1 through 48 properly arranged. The first signature 122, the second signature 124, and the third signature 126 may be stitched together by threads, rather than using staples 128.

After the job defining section 66 has defined one job in step S56 (see FIG. 4), the side stitching process is no longer required.

Finally, in step S66, if necessary, the finished print sample P2 is processed by other processing sequences. For example, depending on the purpose for which the finished print sample P2 is used, i.e., the degree to which the finished print sample P2 is to be finalized, the finished print sample P2 may be processed by respective bookbinding processes, including a cutting process, a cover attaching process, etc.

In this manner, the finished print sample P2, which is simulative of the final print FP, is produced in step S5 (see FIG. 3).

As described above, it is judged whether or not the first processing sequence includes side stitching. If it is determined that the first processing sequence includes side stitching, then the second imposition data 106 corresponding to the second sheet 112, or more specifically, the job defining data 107a through 107c, are generated respectively for jobs D1 through D3, which are defined in relation to respective jobs to be side-stitched. By successively registering jobs, each of which includes a printing process and a sheet folding process, the sheet folding processes can be carried out with suitable timings for producing respective signatures. Therefore, even if the bookbinding process includes side stitching, the form of the final print FP using the first sheet 82 can be simulatively reproduced using the second sheet 112. In other words, the finished print sample P2 can be produced using the POD system (POD machine 24) without causing bookbinding defects such as incorrect collating, etc., to occur.

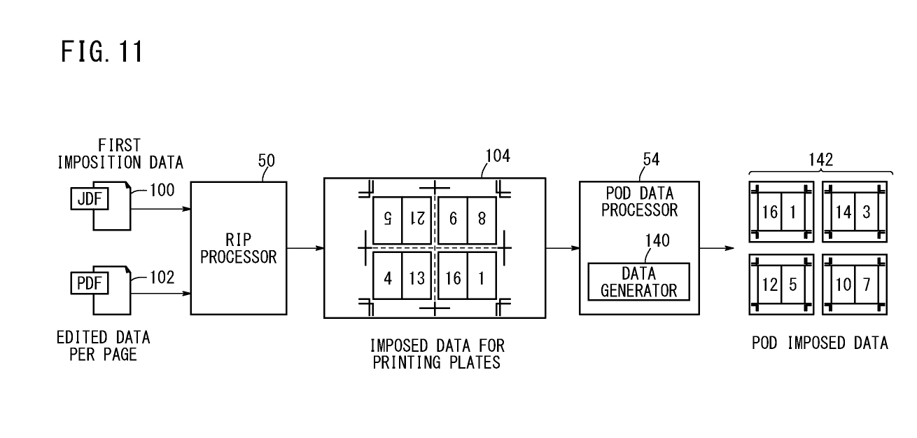

A modification of the present embodiment will be described below with reference to FIG. 11.

In the above embodiment as shown in FIG. 6B, second imposition data 106 are generated, which are suitable for the POD machine 24. According to the modification, the POD data processor 54 includes a data generator 140, which generates POD imposed data 142 (data for printing) corresponding to the second sheet 112, based on the imposed data 104 for printing plates (see FIG. 6A). More specifically, the data generator 140 rearranges the page contents and register marks, etc., of the imposed data 104 for printing plates, and thereafter extracts images in order to generate POD imposed data 142. Accordingly, if a RIP process has already been performed by an apparatus that differs from the image editing apparatus 20, it is unnecessary to reread the imposition data 100 and/or the edited data 102 per page.

Although certain preferred embodiments of the present invention have been shown and described in detail, it should be understood that various changes and modifications may be made to the embodiments without departing from the scope of the invention as set forth in the appended claims.

What is claimed is:

1. A data generating apparatus for generating print data to simulatively reproduce, on a second sheet, the form of a final print, which is produced by performing a first processing sequence including a sheet folding process on a first print that is formed based on a first sheet, wherein the first sheet is different in size from the second sheet, and also generating first imposition data corresponding to the first sheet, and page description data representative of a plurality of pages, comprising:
a side stitch judging section, which refers to the first imposition data to judge whether or not side stitching is included in the first processing sequence;
a job defining section for defining a job including a printing process and a sheet folding process, with respect to each signature to be side-stitched, if the side stitch judging section determines that side stitching is included in the first processing sequence; and
a data generator for generating the print data corresponding to the second sheet, with respect to each the job defined by the job defining section.

2. The data generating apparatus according to claim 1, wherein the print data comprise second imposition data corresponding to the second sheet.

3. The data generating apparatus according to claim 2, further comprising:
an imposition processor for imposing each page represented by the page description data onto the second sheet according to the second imposition data generated by the data generator.

4. The data generating apparatus according to claim 1, wherein the print data comprise imposed data corresponding to the second sheet, the imposed data being generated based on imposed data corresponding to the first sheet onto which each page represented by the page description data is imposed according to the first imposition data.

5. The data generating apparatus according to claim 1, wherein a second processing sequence including a sheet folding process is performed on a second print including images on the second sheet to simulatively reproduce the form of the final print; and
the number of folds formed by the sheet folding process included in the first processing sequence is greater than the number of folds formed by the sheet folding process included in the second processing sequence.

6. The data generating apparatus according to claim 5, wherein the first processing sequence includes a sheet folding process, which represents a plurality of folds to be formed.

7. The data generating apparatus according to claim 5, wherein the second processing sequence includes a sheet folding process, which represents one fold to be formed.

8. A data generating method of generating print data to simulatively reproduce, on a second sheet, the form of a final print, which is produced by performing a first processing sequence including a sheet folding process on a first print that is formed based on a first sheet, wherein the first sheet is different in size from the second sheet, and also generating first imposition data corresponding to the first sheet, and page description data representative of a plurality of pages, the method comprising the steps of:
referring to the first imposition data to judge whether or not side stitching is included in the first processing sequence;
defining a job including a printing process and a sheet folding process, with respect to each signature to be side-stitched, if it is determined that side stitching is included in the first processing sequence; and
generating the print data corresponding to the second sheet, with respect to each the job that is defined.

9. A storage medium storing therein a program for generating print data to simulatively reproduce, on a second sheet, the form of a final print, which is produced by performing a first processing sequence including a sheet folding process on a first print that is formed based on a first sheet, wherein the first sheet is different in size from the second sheet, and also generating first imposition data corresponding to the first sheet, and page description data representative of a plurality of pages, the program enabling a computer to function as:
a side stitch judging section for referring to the first imposition data to judge whether or not side stitching is included in the first processing sequence;
a job defining section for defining a job including a printing process and a sheet folding process, with respect to each signature to be side-stitched, if the side stitch judging section determines that side stitching is included in the first processing sequence; and
a data generator for generating the print data corresponding to the second sheet, with respect to each the job defined by the job defining section.
